(19) United States
(12) Patent Application Publication
(10) Pub. No.: US 2010/0237292 A1
(43) Pub. Date: Sep. 23, 2010

(54) ISOCYANATE MODIFIED EPOXY RESIN AND EPOXY POWDER COATING COMPOSITION THEREOF

(76) Inventors: Joseph Gan, Strasbourg (FR); Emile C. Trottier, Renchen (DE)

Correspondence Address: The Dow Chemical Company, P.O. BOX 1967, Midland, MI, 48641, US

(21) Appl. No.: 12/675,124

(22) PCT Filed: Sep. 25, 2008
(86) PCT No.: PCT/US08/77643

§ 371 Date: Feb. 25, 2010

Related U.S. Application Data
(60) Provisional application No. 60/977,674, filed on Oct. 5, 2007.

(51) Int. Cl. C08L 63/00; C08F 283/10; C08K 3/30; H01B 1/12

(52) U.S. Cl. 252/500; 525/528; 524/589; 524/423

(57) ABSTRACT

An epoxy resin composition comprises an isocyanate modified epoxy resin, which is a reaction product of (a) a multi-functional epoxy resin having an epoxy functionality of greater than about 2.2 and (b) a diisocyanate compound. An epoxy powder coating composition comprises the epoxy resin composition. The isocyanate modified epoxy resin has a high resin softening point and a high cross-linked glass transition temperature Tg for powder coating applications.

### BACKGROUND OF THE INVENTION

1. Field of the Invention

The present invention relates to an epoxy resin composition comprising an isocyanate modified epoxy resin which has a high resin softening point and a high resin cross-linked glass transition temperature for powder coating applications.

2. Description of Background and Related Art

It is known in the art to modify epoxy resins with isocyanate compounds to form epoxy resins comprising oxazolidone rings. Epoxy resin coating products made from isocyanate modified epoxy resins are found to have improved performances such as higher resin glass transition temperatures (resin Tg) and better chemical resistance.

U.S. Pat. No. 5,112,932 discloses that an epoxy-terminated polyoxazolidone (also referred as isocyanate modified epoxy resin) is prepared by reacting an epoxy resin with a polyisocyanate compound using stoichiometric excess of epoxy resin (isocyanate/epoxy ratio lower than 1). The epoxy-terminated polyoxazolidone exhibits improved resin Tg and resistance to chemicals.

U.S. Pat. Nos. 5,314,720 and 5,721,323 describe a cure inhibitor comprising a boric acid, which can be added to an epoxy resin composition to inhibit a curing reaction between an epoxy resin and an isocyanate compound in the epoxy resin composition. The boric acid inhibitor lengthens the gel time and improves the cure cycle of the epoxy resin composition.

U.S. Pat. No. 5,545,697 discloses an epoxy resin composition comprising an oxazolidone ring-containing epoxy resin, a halogen-containing epoxy resin, and a curing agent. The epoxy resin composition was found to have improved performance in heat resistance, tenacity, storage stability and flame retardancy.

U.S. Pat. No. 6,432,541 discloses an epoxy resin composition comprising from about 1 to about 100 weight percent of a thermoplastic oxazolidone ring-containing epoxy resin. The epoxy resin is a reaction product of a polyepoxide and a polyisocyanate, wherein the polyisocyanate has an isocyanate functionality of from 1.8 to 2.2 and the polyepoxide has an epoxide functionality of from 1.8 to 2.2. The epoxy resin composition has an improved peel strength and resin Tg.

Although numerous compositions and processes for preparing isocyanate modified epoxy resins have been described in the literature, there is no disclosure nor suggestion in the known art that teaches that an isocyanate modified epoxy resin can be produced by reaction of a diisocyanate compound and a multi-functional epoxy resin with an epoxy functionality of greater than 2.2 to increase the resin softening point of the resulting isocyanate modified epoxy resin. There is also no disclosure nor suggestion in the known art that teaches that an epoxy powder coating composition comprising the isocyanate modified epoxy resin having an increased resin cross-linked glass transition temperature (resin cross-linked Tg) for powder coating applications.

An epoxy powder coating composition comprising an epoxy resin with a high softening point and a high resin cross-linked Tg is desirable for many uses. For example, the epoxy powder coating composition may be used in coating crude oil pipes, such as oil pipe systems for high temperature crude oil transportation from deep water wells. The oil pipe system applied with the epoxy powder coating composition having a high cross-linked Tg (e.g. Tg greater than about 160° C.) can be used to transport oil over longer distances at higher temperatures for a longer period of time than conventional epoxy resin coating compositions.

In addition, the epoxy powder coating composition can also be useful in electrical applications which require a high resin cross-linked Tg (e.g. Tg greater than about 160° C.) or an ultra-high resin cross-linked Tg (e.g. powder coated rotors used in motors and generators which may required resin a cross-linked Tg as high as or greater than 200° C.).

Accordingly, there is a need to develop a new isocyanate modified epoxy resin, which is capable of achieving high operating temperatures including a high resin softening point (e.g. a softening point greater than about 90° C.), and an epoxy powder coating composition having a high resin cross-linked Tg (e.g. a resin cross-linked Tg greater than about 160° C.).

### SUMMARY OF THE INVENTION

One aspect of the present invention is directed to an epoxy resin composition comprising an isocyanate modified epoxy resin, wherein the isocyanate modified epoxy resin is a reaction product of (a) a multi-functional epoxy resin having an epoxy functionality of greater than about 2.2 and (b) a diisocyanate compound.

Another aspect of the present invention is directed to an epoxy powder coating composition comprising the above epoxy resin composition.

A further aspect of the present invention is directed to an article comprising the above epoxy powder coating composition.

### DETAILED DESCRIPTION OF THE INVENTION

In the following detailed description, the specific embodiments of the present invention are described in connection with its preferred embodiments. However, to the extent that the following description is specific to a particular embodiment or a particular use of the present techniques, it is intended to be illustrative only and merely provides a concise description of the exemplary embodiments. Accordingly, the present invention is not limited to the specific embodiments described below, but rather; the present invention includes all alternatives, modifications, and equivalents falling within the true scope of the appended claims.

Unless otherwise stated, a reference to a compound or component includes the compound or component by itself, as well as in combination with other compounds or components, such as mixtures or combinations of compounds.

As used herein, the singular forms “a,” “an,” and “the” include the plural reference unless the context clearly dictates otherwise.

The present invention provides an epoxy resin composition comprising an isocyanate modified epoxy resin which has a high resin softening point; and an epoxy resin composition comprising the epoxy resin composition which has a high resin cross-linked Tg for powder coating applications.

The resin softening point is a temperature at which the resin starts to soften or melt. The resin softening point can be measured by a Mettler Softening Point (M.S.P.) measurement equipment. The resin softening point of the isocyanate modified epoxy resin of the present invention is generally greater than about 90° C., preferably greater than about 95° C., and more preferably more than about 100° C. The resin softening point may preferably be lower than 150° C., more preferable lower than about 130° C.

In a preferred embodiment, the resin softening point may be about 95° C. to about 150° C., and preferable about 100° C. to about 130° C.

The resin cross-linked Tg is a glass transition temperature of an cured epoxy resin, i.e. an epoxy resin with most or all of the epoxy groups (also referred as “epoxide groups”) in the epoxy resin cross-linked (cured) with a curing agent or self polymerized. The resin cross-linked Tg of the cured epoxy powder coating composition of the present invention is generally greater than about 160° C., preferably greater than about 170° C., more preferably greater than about 190° C., and most preferably greater than about 200° C.

In a preferred embodiment, the resin cross-linked Tg of the cured epoxy powder coating composition may be greater than about 200° C. and below about 250° C.

The isocyanate modified epoxy resin of the present invention is a product of a reaction of a diisocyanate compound and a multi-functional epoxy resin. The reaction incorporates the isocyanate groups from the diisocyanate compound into the multi-functional epoxy resin backbone to form a poly-oxazolidone structure. The product is also referred to as an oxazolidone ring-containing epoxy resin.

The formation of the poly-oxazolidone structure within the multi-functional epoxy resin backbone increases the molecular weight of the multi-functional epoxy resin, and thus increases the resin softening point of the resulting isocyanate modified epoxy resin. The resin cross-linked Tg of the cured epoxy powder coating composition comprising the isocyanate modified epoxy resin is also higher because the addition of the poly-oxazolidone structure into the multi-functional epoxy resin backbone increases both the epoxy backbone structure stiffness and the epoxy cross-linking density.

The multi-functional epoxy resin as used herein refers to a compound or mixture of compounds having an epoxy functionality of greater than about 2.2, preferably greater than about 2.5, more preferably greater than about 3.0, and most preferably greater than about 3.5. The multi-functional epoxy resin may preferably be less than about 10, more preferably less than about 8, and most preferably less than about 6.

In a preferred embodiment, the multi-functional epoxy resin may have an epoxy functionality of about 2.5 to about 10, more preferably about 3.0 to about 8, and most preferably about 3.5 to about 6.

Examples of the multi-functional epoxy include epoxy novolac resins (i.e. a reaction product of phenols and aldehydes, e.g. formaldehyde), such as epoxidized bisphenol A novolac, cresol epoxy novolac, alkylated epoxy novolac; dicyclopentadiene modified epoxy, such as dicyclopentadiene phenol epoxy novolac; glycidyl ether of tetraphenolethane; diglycidyl ether of bisphenol-A; diglycidyl ether of bisphenol-F; and diglycidyl ethers of hydroquinone, trisepoxy, bisphenol-S epoxy; epoxy of dihydroxyl fluorine 9-bisphenyl; and any combination thereof or the like. The epoxy novolac resin is the preferred multi-functional epoxy resin used for the present invention.

Examples of commercially available multi-functional epoxy resin that are suitable for the present invention include, for example, epoxy novolac resin such as D.E.N.™ 438 or D.E.N.™ 439, available from The Dow Chemical Company; cresole epoxy novolacs such as QUATREX™ 3310, 3410 and 3710, available from Huntsman; trisepoxy compounds, such as TACTIX™ 742, also available from Huntsman.

In general, the diisocyanate compound used to modify the multi-functional epoxy resin in the present invention is an isocyanate compound having an isocyanate functionality of about 2.0 to about 2.4, preferably between about 2.05 to about 2.3, more preferably between about 2.1 to about 2.25, and most preferably between about 2.15 to about 2.2.

It has been discovered in the present invention that the higher the isocyanate functionality of the isocyanate compound, the less amount of isocyanate compound will react with the multi-functional epoxy resin. If the functionality of the isocyanate compound is too high, the resulting isocyanate modified epoxy resin will have a lower resin softening point because less amount of isocyanate compound can react with the multi-functional epoxy resin before the reaction reaches the gelling point of the isocyanate modified epoxy resin.

As used herein, the term “gelling point” means a starting point when an epoxy resin starts to form a tri-dimensional network and the epoxy resin can not be melted to become liquid state.

When the functionality of the isocyanate compound is higher, the reaction between the multi-functional epoxy resin and the isocyanate compound will form the tri-dimensional network earlier or quicker and reach the gelling point of the resulting isocyanate modified epoxy resin much sooner. The formation of the tri-dimensional network inhibits further reaction between the isocyanate compound and the multi-functional epoxy resin. Accordingly, the higher the isocyanate functionality, the lower the amount of isocyanate compound which can react with the multi-functional epoxy resin before the reaction reaches the gelling point of the isocyanate modified epoxy resin.

For example, for an isocyanate compound with a functionality about of 2.7, the estimated % of the isocyanate compound which can react with a multi-functional epoxy resin (e.g. D.E.N.™ 438) before the reaction reaches the gelling point of the isocyanate modified epoxy resin is less than about 10%. However, for an isocyanate compound with a functionality of about 2, the estimated % of the isocyanate compound which reacts with the multi-functional epoxy resin (e.g. D.E.N.™ 438) before the reaction reaches the gelling point of the isocyanate modified epoxy resin increases to about 13-14%.

The more the isocyanate compound can react with the epoxy resin before the reaction reaches to the gelling point of the isocyanate modified epoxy resin, the higher the molecular weight of the resulting isocyanate modified epoxy resin, thus the higher the softening point of the isocyanate modified epoxy resin.

On the other hand, if the isocyanate functionality is too low, the resulting isocyanate modified epoxy resin will have a low functionality and thus low molecular weight and low resin softening point. The cured isocyanate modified epoxy resin made from the isocyanate compound with low functionality will also have a low cross-linking density and, as a result, a low resin cross-linked Tg.

Accordingly, it is important to use the diisocyanate compound to modify the multi-functional epoxy resin in order to have high levels of isocyanate compound react with the multi-functional epoxy resin and thus incorporate more oxazolidone rings into the epoxy resin backbone. The use of the diisocyanate compound increases the resin softening point of the resulting isocyanate modified epoxy resin and provides a higher cross-linking density, thus a higher resin cross-linked Tg and better toughness and adhesion, throughout the isocyanate modified epoxy backbone.

Examples of suitable diisocyanates include 4,4′-diphenylmethane diisocyanate (MDI), toluene diisocyanate (TDI), and xylylene diisocyanate (XDI); aliphatic diisocyanate (comprising alicyclic diisocyanate) such as hexamethylene diisocyanate (HMDI), isophorone diisocyanate (IPDI), 4,4′-methylenebis(cyclohexylisocyanate), trimethyl hexamethylene diisocyanate, and dianisidine diisocyanate, toluidine diisocyanate, m-xylylene diisocyanate, 1,5-naphthylene diisocyanate, p-phenylene diisocyanate, 1,4-diethylbenzene-beta, beta′-diisocyanate, bexamethylene diisocyanate (HMDI), isophorone diisocyanate (IPDI) and 4,4′-methylene bis(cyclohexylisocyanate), and any mixture thereof or the like.

Preferred examples of the diisocyanates include 4,4′-methylene bis(phenylisocyanate) (MDI) and isomers thereof, polymeric MDI, and toluene diisocyanate (TDI) and isomers thereof, any mixture thereof or the like.

More specific examples of the diisocyanates are toluene diisocyanate (TDI) and isomers thereof, such as 2,4-toluene diisocyanate and 2,6-toluene diisocyanate; methylene bis(phenyl isocyanates) (MDI) and isomers thereof, such as 2,2′-methylene bis(phenylisocyanate), 2,4′-methylene bis(phenylisocyanate), and 4,4′-methylene bis(phenylisocyanate).

The more preferred diisocyanates are TDI and its isomers. TDI comprises two isocyanate groups of different reactivity on a single phenyl ring in its molecule structure and therefore has much higher (approximately 48%) isocyanate content than other isocyanate compounds. Because of the high isocyanate content, TDI provides high levels of the isocyanate content, thus more oxazolidone rings incorporation, into the multi-functional epoxy resin. The resulting TDI modified epoxy resin can potentially reach very high resin cross-linked Tg because of the presence of the high levels of oxazolidone rings in the multi-functional epoxy resin backbone which increases the cross-linking density of the isocyanate modified epoxy resin.

The isocyanates may be used as a mixture of two or more of the isocyanates. The isocyanates may also be any mixture of the isomers of an isocyanate, for example a mixture of the 2,4- and 2,6-isomers of MDI or a mixture of any 2,2′-, 2,4′- and 4,4′-isomers of TDI.

Examples of commercially available diisocyanate that are suitable for the present invention include, for example, ISONATE™ M124, ISONATE™ M125, ISONATE™ OP 50, and VORANATE™ T-80, available from The Dow Chemical Company,

In general, the amount of the multi-functional epoxy resin present in the epoxy resin composition is from about 98 percent to about 75 percent by weight, and preferably, from about 95 percent to about 85 percent by weight based on the total weight of the epoxy resin and isocyanate compound in the epoxy resin composition. The amount of isocyanate compound is from about 2 percent to about 25 percent by weight, and preferably, from about 5 percent to about 15 percent by weight based on the total weight of the epoxy resin and isocyanate compound in the epoxy resin composition.

The isocyanate modified epoxy resin of the present invention may also comprise hybrid oxazolidone/isocyanurate rings to increase cross-linking density and provide various cross-linked structure to the isocyanate modified epoxy resin. The isocyanurate ring is formed by a trimerization reaction of three isocyanate groups. In general, about 5 to about 100 percent of the original isocyanate groups convert to oxazolidone rings and from about 95 to 0 percent of the original isocyanate groups convert to isocyanurate rings. Examples of the hybrid oxazolidone/isocyanurate rings include those described in U.S. Pat. No. 5,112,932, incorporated herein by reference.

The epoxy resin composition of the present invention may also comprise a catalyst or a mixture of two or more catalysts. The catalysts suitable for making the isocyanate modified epoxy resin include those compounds containing amine, such as primary, secondary, tertiary, aliphatic, cycloaliphatic, aromatic or heterocyclic amines; compounds containing phosphine, heterocyclic nitrogen, ammonium, phosphonium, arsonium or sulfonium moieties, and any combination thereof.

Preferred examples of catalyst are the heterocyclic nitrogen and amine-containing compounds. Examples of such heterocyclic nitrogen compounds include those described in U.S. Pat. No. 4,925,901 and U.S. Pat. No. 5,112,932, incorporated herein by reference.

More preferred catalysts suitable for the present invention include amine-containing compounds such as 1,8-Diazabicyclo [5.4.0]undec-7-ene (DBU), imidazole derivatives including 2-methyl imidazole, 2-phenyl imidazole (2-PhI); phosphonium and ammonium salts; and any mixture thereof or the like. Most preferred catalysts used in the present invention are 2-PhI and DBU. It has been discovered that both catalysts yield high percentage of oxazolidone ring (e.g. greater than about 95% of oxazolidone conversion), and low percentage of the formation of isocyanurate ring (e.g. less than 5% of isocyanurate conversion) under the reaction temperatures being considered (i.e. about 150° C. to about 200° C.).

The amount of catalysts used for the present invention may be from about 10 to about 50000 ppm, preferably between about 50 to about 10000 ppm, more preferably between about 100 to about 5000 ppm, and most preferably between about 200 to about 2000 ppm based on the total weight of the epoxy resin composition.

The epoxy resin composition may further comprise a reaction inhibitor to control the reaction of the diisocaynate compound and the multi-functional epoxy resin. After the reaction between the multi-functional epoxy resin and the diisocyanate compound is completed, the solid isocyanate modified epoxy resin product usually is kept at high temperatures (for example, between about 150° C. to about 200° C.) and the melt viscosity of the isocyanate modified epoxy resin tends to increase due to the presence of the catalyst. In addition, the presence of the catalyst may further enhance the homopolymerization reaction between the epoxy groups presence in the reaction. In order to inhibit the homopolymerization reaction of the epoxy groups, a reaction inhibitor is used to deactivate the catalyst or interrupt the reaction process, thereby inhibiting further reaction between the epoxy groups.

Strong inorganic acids and the anhydrides and esters of the acids (including half esters and part esters) have been found to be particularly effective as the reaction inhibitors. The term “strong acid” means an organic acid having a pKa value below about 4, and preferably below about 2.5.

Examples of the reaction inhibitors include inorganic acids such as hydrochloric acid, sulfuric acid and phosphoric acid; inorganic acid anhydrides such as phosphoric acid anhydride (P₂O₅); esters of inorganic acids such as dimethyl sulfate; organic acids such as alkyl, aryl and aralkyl and substituted alkyl, aryl and aralkyl sulfonic acids such as p-toluene sulfonic acid and phenyl sulfonic acid and stronger organic carboxylic acids such as trichloroacetic acid and alkyl esters of the acids, such as the alkyl esters of p-toluene sulfonic acid, e.g., methyl-p-toluene sulfonate, and ethyl-p-toluenesulfonate and methanesulfonic acid methylester. An example of an acid anhydride of a strong organic acid such as p-toluene sulfonic acid anhydride can also be used as a reaction inhibitor.

Preferably, the reaction inhibitor may be the alkyl esters of sulfuric acid: the aryl or aralkyl sulfonic acids and the alkyl esters of the acids. More preferably, an alkyl ester of p-toluene sulfonic acid, particularly methyl or ethyl-p-toluene sulfonic acid can be employed as the reaction inhibitor in the present invention.

The amount of reaction inhibitor added to the reaction epoxy resin composition is dependent on the specific inhibitor employed and the catalyst employed in preparing the epoxy resin composition of the present invention. In general, the inhibitor is added in an amount sufficient to overcome the catalytic activity of the catalyst. Preferably, at least about 0.9 equivalents of the inhibitor, and more preferably, at least about 2 equivalents of the inhibitor, are added for each equivalent of the catalyst employed. Although the maximum amount of inhibitor added to the reaction mixture is dependent on the desired properties of the epoxy resin and the expense of adding excess inhibitor, the inhibitor is preferably added in an amount not exceeding about 5 equivalents for each equivalent of catalyst in the epoxy resin composition.

Another aspect of the present invention is directed to the epoxy powder coating composition comprising the epoxy resin composition of the present invention, wherein the epoxy resin composition comprises the isocyanate modified epoxy resin. The epoxy powder coating composition of the present invention may further comprise a curing agent and a catalyst.

Examples of the curing agent include any of the curing materials known to be useful for curing epoxy resin based coating compositions. Such materials include, for example, polyamine, polyamide, polyaminoamide, dicyandiamide, polyphenol, polymeric thiol, polycarboxylic acid and anhydride, polyol, tertiary amine, quaternary ammonium halide, and any combination thereof or the like. Other specific examples of the curing agent include dicyandiamide, phenol novolacs, bisphenol-A novolacs, phenol novolac of dicyclopentadiene, diphenylsulfone, styrene-maleic acid anhydride (SMA) copolymers, and any combination thereof.

Dicyandiamide (DICY) is a preferred curing agent in the present invention. DICY has the advantage of providing delayed curing since it requires relatively high temperatures and thus can be added to an epoxy resin and stored at room temperature (about 25° C.).

The preferred ratio of curing agent to the isocyanate modified epoxy resin varies depending upon the curing agent selected and the intended use of the epoxy powder coating composition. In general, the equivalent ratio of curing agent to epoxy resin is about 0.1:1 to about 10:1, preferably about 0.2:1 to about 2:1, more preferably from about 0.5:1 to about 5:1, and most preferably from about 0.7:1 to about 1:1.

The epoxy powder coating composition of the present invention may further comprise a catalyst, an accelerator, or a mixture of catalyst and accelerator to accelerate the curing reaction between the isocyanate modified epoxy resin and the curing agent.

An accelerator conventionally employed in powder coating compositions can be employed in the epoxy powder coating composition of the present invention.

Examples of the accelerator used in the present invention include stannous salts of monocarboxylic acids, such as stannous octoate and stannous laurate, various alkali metal salts such as lithium benzoate, certain heterocyclic compounds such as imidazole and benzimidazole compounds and salts thereof, onium compounds such as quaternary ammonium and phosphonium compounds and tertiary amines and phosphines.

The catalyst (as distinguished from co-crosslinker) may comprise on average no more than about 1 active hydrogen moiety per molecule. The active hydrogen moiety comprises hydrogen atom bonded to an amine group, a phenolic hydroxyl group, or a carboxylic acid group.

Examples of suitable catalyst useful in the present invention may include compounds containing amine, phosphine, heterocyclic nitrogen, ammonium, phosphonium, arsonium, sulfonium moieties, and any combination thereof. More preferred catalysts are the heterocyclic nitrogen-containing compounds and amine-containing compounds and even more preferred catalysts are the heterocyclic nitrogen-containing compounds.

The amine and phosphine moieties in catalysts are preferably tertiary amine and phosphine moieties; and the ammonium and phosphonium moieties are preferably quaternary ammonium and phosphonium moieties.

Among preferred tertiary amines that may be used as catalysts are those mono- or polyamines having an open-chain or cyclic structure which have all of the amine hydrogen replaced by suitable substituents, such as hydrocarbyl radicals, and preferably aliphatic, cycloaliphatic or aromatic radicals.

Specific examples of these amine catalysts include, among others, 1,8-diazabicyclo[5.4.0] undec-7-en (DBU), methyl diethanol amine, triethylamine, tributylamine, dimethyl benzylamine, triphenylamine, tricyclohexyl amine, pyridine and quinoline. Preferred amines are the trialkyl, tricycloalkyl and triaryl amines, such as triethylamine, triphenylamine, tri-(2,3-dimethylcyclohexyl)amine, and the alkyl dialkanol amines, such as methyl diethanol amines and the trialkanolamines such as triethanolamine. Weak tertiary amines, for example, amines that in aqueous solutions give a pH less than 10 in aqueous solutions of 1 M concentration, are particularly preferred. Especially preferred tertiary amine catalysts are benzyldimethylamine and tris-(dimethylaminomethyl)phenol.

Examples of suitable heterocyclic nitrogen-containing catalysts include those described in U.S. Pat. No. 4,925,901, which is incorporated herein by reference.

Preferable heterocyclic secondary and tertiary amines or nitrogen-containing catalysts which can be employed herein include, for example, imidazoles, benzimidazoles, imidazolidines, imidazolines, oxazoles, pyrroles, thiazoles, pyridines, pyrazines, morpholines, pyridazines, pyrimidines, pyrrolidines, pyrazoles, quinoxalines, quinazolines, phthalozines, quinolines, purines, indazoles, indoles, indolazines, phenazines, phenarsazines, phenothiazines, pyrrolines, indolines, piperidines, piperazines, and any combination thereof or the like. Especially preferred are the alkyl-substituted imidazoles; 2,5-chloro-4-ethyl imidazole; and phenyl-substituted imidazoles, and any mixture thereof. Even more preferred are N-methylimidazole 2-methylimidazole; 2-ethyl-4-methylimidazole; 1,2-dimethylimidazole; 2-methylimidazole and imidazole-epoxy reaction adducts. Especially preferred are 2-phenylimidazole, 2-methylimidazole and 2-methylimidazole-epoxy adducts.

Most preferred examples of the catalyst suitable for the present invention include 2-methyl imidazole, 2-phenyl imidazole, imidazole derivative, 1,8-Diazabicyclo[5.4.0]undec-7-ene (DBU), 2-methyl imidazole-epoxy adduct, such as EPON™ P101 (available from Hexion Chemical), isocyanate-amine adduct (available from Degussa), and any combination thereof.

The epoxy powder coating composition of the present invention may additionally comprise a Lewis acid. The Lewis acid may be added in the catalyst to help control the reactivity (e.g. increase the gel time of the formation of the powder coating) and, in some cases, to further increase the resin cross-linked Tg of the epoxy powder coating composition of the present invention.

It has been discovered that the use of the Lewis acid increases the gel time of the epoxy powder coating composition to allow usage of higher levels of catalyst and to increase epoxy cross-linking density. The use of Lewis acid contributes to better control of gel time (reactivity) for the powder coating to have better surface properties such as wetting.

The Lewis acids useful for the present invention include halides, oxides, hydroxides, and alkoxides of zinc, tin, titanium, cobalt, manganese, iron, silicon, aluminum, boron, other Lewis acids that tend to have a relatively weak conjugate base such as boric acid, and any mixture thereof or the like.

More specific examples include Lewis acids of boron and anhydrides of Lewis acids of boron. Preferred examples of Lewis acids of boron include boric acid, metaboric acid, substituted boroxines (such as trimethoxyboroxine, triethyl boroxine), substituted oxides of boron, alkyl borates, and any mixture thereof or the like.

The Lewis acid may form a mixture with the amine catalyst including any amine-containing compound stated above. The Lewis acid and amines catalyst mixture can be combined before mixing into the epoxy powder coating composition or mixed with the amines catalyst in-situ to make a curing catalyst combination.

The epoxy powder coating composition of the present invention may comprise at least about 0.1 moles of Lewis acid per mole of amine catalyst, and preferably at least about 0.3 moles of Lewis acid per mole of amine catalyst. However, the epoxy powder coating composition preferably comprises no more than about 5 moles of Lewis acid per mole of amine catalyst, and more preferably no more than about 3 moles of Lewis acid per mole of amine catalyst. Preferably, the amount of the Lewis acid present in the epoxy resin powder coating composition is at least about 0.1 moles and no more than about 5 moles of Lewis acid per mole of amine catalyst. More preferably, the amount of the Lewis acid is at least about 0.3 moles and no more than about 3 moles of Lewis acid per mole of amine catalyst.

The total amount of catalyst is from about 0.1 percent to about 10 percent, preferably from about 0.2 percent to about 8 percent, more preferably from about 0.4 percent to about 6 percent, and most preferably from about 0.8 percent to about 4 percent by weight based on the total weight of the epoxy powder coating composition.

The epoxy powder coating composition of the present invention may optionally contain other additives which are useful for their intended uses. For example, the epoxy powder coating composition useful for coating formulations may optionally contain stabilizers, surfactants and flow modifiers, fillers, pigments and matting agents. The epoxy powder coating composition useful for laminate and composite may optionally contain stabilizers, fillers, flow-modifiers and chopped fibers. Examples of the additives include BaSO₄, TiO₂, Modaflow, Acronal 4F, Byk 361 (as a flow modifier), and benzoin as a degassing agent.

The total amount of the additives other than pigments, fillers and chopped fibers in the epoxy powder coating composition is generally no more than about 5 percent by weight, and preferably no more than about 3 percent by weight based on the total weight of the epoxy powder coating composition. The total amount of the pigments, fillers and chopped fibers is generally no more than about 40 percent by weight, and preferably no more than about 30 percent by weight based on the total weight of the epoxy powder coating composition.

The epoxy powder coating composition of the present invention may be applied to a substrate by various methods. For example, in one embodiment, the epoxy powder coating composition may be applied to a substrate by (1) heating the substrate to a suitable curing temperature for the composition; and (2) applying epoxy powder coating composition by known means such as an electrostatic spray or a fluidized bed. In another embodiment, the epoxy powder coating composition may be applied to a cold substrate by (1) applying the epoxy powder to the substrate (e.g. with an electrostatic application method); and (2) heating the powder and the substrate to a temperature at which the powder flows and cures.

The epoxy powder coating composition of the present invention has the advantages of having a higher resin cross-linked Tg than a powder coating composition comprising other epoxy resins, such as di-functional epoxy resins. The epoxy powder coating composition provides improved coating performance such as reduced sintering tendency (the tendency for the powder particles to agglomerate to form lumpy block) over storage time and improved curing cycle of the epoxy powder coating composition including a shorter curing time due to the use of higher levels of catalysts.

There are many useful applications of the epoxy powder coating composition of the present invention. In particularly, the epoxy powder coating composition of the present invention is useful for applications requiring high heat resistance and good storage stability (e.g. allow a substrate to operate at temperatures of up to about 150° C. for prolonged periods of time, i.e. greater than about five years).

For example, the epoxy powder coating composition may be used in coating crude oil pipes, such as oil pipe systems for high temperature crude oil transportation from deep water wells. The pipe system with the epoxy powder coating composition of the present invention can be used to transport oil over longer distances at higher temperatures for a longer period of time than conventional epoxy resin coating compositions.

In addition, the epoxy powder coating composition may also be used in electrical applications which require a high cross-linked Tg (e.g. Tg greater than about 160° C.) or an ultra-high cross-linked Tg (e.g. powder coated rotors used in motors and generators with cross-linked Tg greater than 200° C.).

Other applications of the epoxy powder coating composition include electrical laminates, composite materials, electrical encapsulation, and other epoxy systems such as paints, adhesives, molding materials, and electronic appliance materials.

The following examples and comparative examples further illustrate the present invention in detail but are not to be construed to limit the scope thereof.

### EXAMPLES

Various terms and designations used in the following examples are explained herein below:

D.E.R.™ 330 is the trademark for a diglycidyl ether of bisphenol A having an epoxy equivalent weight (EEW) between 177 and 189 and an epoxy functionality of 2.0.

D.E.N.™ 438 is the trademark for an epoxidized phenol formaldehyde novolac resin having an EEW between 176 and 181 and an epoxy functionality of 3.6.

TDI stands for toluene diisocyanate.

MDI stands for diphenylmethane diisocyanate.

DICY stands for dicyandiamide.

The following methods, carried out according to the described procedures, were used to test the performance of the isocyanate modified epoxy resin and the epoxy powder coating composition comprising the isocyanate modified epoxy resin:

Epoxy equivalent weight (EEW) was measured by a colorimetric titration of epoxy resin samples (about 0.4 mg) with 0.1 M perchloric acid in the presence of tetraethylammonium bromide in glacial acetic acid. Crystal violet was employed as indicator according to ASTM D 1652 method.

Melt Viscosity was measured by an Abrecht Cone and Plate viscometer (“C” cone) according to ASTM D 4287 method.

The resin softening point is the temperature at which the resin starts to soften or melt. The resin softening point was measured by a Mettler FP 80/FP83 instrument according to RPM 108C method and is referred as Mettler Softening Point (M.S.P.) in the following Examples.

Resin glass transition temperature (resin Tg) is the temperature when a rigid amorphous polymer softens to a flexible rubberlike material. The resin Tg was measured by Differential Scanning Calorimetry (DSC) with a Mettler instrument. Epoxy resin samples of approximately 10-15 mg were scanned from 0 to 120° C. with scan rate of 10 K/min. The same sample was scanned twice to obtain two measurements of Tg1/Tg2. The resin Tg shown in the following tables is the average value of the Tg1 and Tg2.

The resin cross-linked glass transition temperature (resin cross-linked Tg) is the glass transition temperature of a cured resin and is difference from the resin Tg, which is the glass transition temperature of an un-cured resin.

The resin cross-linked Tg of the epoxy powder coating composition was measured by DSC with a Mettler instrument. The components of powder coating composition (epoxy resin, hardener, catalyst, fillers) were weighed (batch size 1 kg), mixed using a Mixaco laboratory mixer for 2 minutes at 400 rpm, and then melt extruded in a Werner & Pfleiderer ZSK-30 twin-screw extruder (Tset=100° C., speed at 300 rpm). The resulting resin was manually reduced to chips, ground in a Hosokawa-Micropul mill to give the final powder coating composition product. A sample of the epoxy powder coating composition of approximately 10-15 mg was first scanned from 0° C. to 230° C. with scan rate of 10 K/min. The sample was cooled to 0° C. and scanned with the same scan rate for second time to measure the resin cross-linked Tg.

Flexibility was measured according to ASTM A775 method. A Wagner electrostatic spray gun, which has a fluidized feeding chamber (Type E.P.M. 200) was used to apply the epoxy powder coating composition onto a hot (about 235° C.) 6 mm shot-blasted steel panel (100×60×6 mm), with 1 minute post-cure. The coated panels were then immediately water quenched to avoid over-reaction. The bend test of the coated panel was performed until the coating starts to crack at room temperature. A mandrel of diameter of 20 mm was used. The coated panel was bent over the mandrel until such time that the coating was visibly cracked. At this point the panel was removed and the deflection angle of the bending was measured. The larger the deflection angle achieved prior to coating failure (i.e. cracking) the greater the flexibility.

Impact resistance was measured according to ASTM 614 method. Front and reverse impact tests were conducted using a 4 lbs (1.8 kg) weight and a ½ inch (1.3 cm) tup. A tup is a ball having a diameter of 1.3 cm which is dropped on the top of the coated panel to create an impact on the coated surface. If the coating resists the impact and will not crack, the coating passes the test. Pass (p) and fail (f) values are recorded at various impact energies.

Reactivity (Gel time at 180° C.) was measured according to DIN 55990-8 with a Coesfeld test equipment. A quantity of powder coating composition was measured and was placed in the heated crucible and allowed to melt. The time was recorded between the epoxy powder coating composition starts to melt until the epoxy powder coating composition reaches gelling point—this is determined as that point at which it is no longer possible to stir the epoxy powder coating composition.

Chemical resistance was measured by the “acetone double rub” method. A small cotton wool pad was soaked with acetone, applied to the coating and rubbed back and forth (“double rubs”) over the same area with even pressure until the continuity of the coating was destroyed. The number of “double rubs” necessary to destroy the continuity of the coating was recorded.

Hot water test was measured according to ASTM D870-54 method. A coated panel was immersed in de-ionized water at 80° C. for 2 days. Adhesion is then determined using the following cross hatch test.

After the panel was removed from the water bath, the panel was scored to produce a rectangular form on the panel. The panel was allowed to cool. A force was applied to the scored by a utility knife to try to remove the coating on the panel. The coating is then given a numerical rating 1 to 4 to indicate degree of coating disbondment (1=little disbondment and 5=complete disbondment).

### Epoxy Resin Preparation A

D.E.R.™ 330 epoxy resin having an epoxy functionality of about 2.0 was heated up to 100° C. under nitrogen purge in a reactor equipped with an electrically driven stirrer, air and nitrogen inlets, sample port, condenser and thermocouple. Liquid solid 1,8-diazabicyclo[5,4,0] undec-7-en (a catalyst available as AMICURE DBU-E™ by Anchor) of 1500 ppm (based on the total weight of D.E.R.™ 330 and the isocyanate compound in the reaction mixture) was first dissolved in xylene to give 70 wt % solid solution, then added to the D.E.R.™ 330 epoxy resin at 125° C. The reaction mixture was heated to 145° C. in 40 minutes.

MDI or TDI was charged into the D.E.R.™ 330 epoxy resin via an additional funnel, portion by portion, within a period of 60-120 minutes depending on the amount of MDI or TDI to be added and the heat of the exothermic reaction. The reaction temperature rose to at least 170-190° C. by the heat of reaction. After the end of the addition, the reaction mixture was kept at a temperature of at least 165° C. for 30 minutes until the theoretical epoxy equivalent weight (EEW) for the specific isocyanate modified epoxy resin (e.g. TDI modified D.E.N.™ 438 epoxy resin or MDI modified D.E.R.™ 330 epoxy resin) was reached, i.e. when most or all of the isocyanate groups react with the corresponding amount of epoxy groups. The EEW of the isocyanate modified epoxy resin was measured by the colorimetric titration method stated above.

In the case when 2-phenylimidazole (2-PhI) was used as reaction catalyst, solid 2-PhI of 400 ppm (based on the total weight of D.E.R.™ 330 and isocyanate in the product) was first dissolved in methanol to give 40 wt % solid solution before addition to the epoxy resin.

### Epoxy Resin Preparation B

D.E.N.™ 438 epoxy novolac resin with an epoxy functionality of about 3.6 was heated up to 100° C. under nitrogen purge in a reactor equipped with an electrically driven stirrer, air and nitrogen inlets, sample port, condenser and thermocouple.

Liquid DBU of 1500 ppm (based on the total weight of D.E.N.™ 438 epoxy novolac resin and the isocyanate compound in the product) was first dissolved in xylene to give 70 wt. % solid solution, then added to the epoxy novolac resin at 125° C. The mixture was heated to 155° C. in 40 minutes.

MDI or TDI was charged into the epoxy novolac resin via an additional funnel, portion by portion, within a period of 30 to 45 minutes depending on the amount of MDI or TDI to be added and the heat of the exothermic reaction. The reaction temperature rose to at least 160° C. by the heat of reaction. After the end of the addition, the reaction mixture was kept at a temperature of at least 165° C. for 30 minutes until the theoretical epoxy equivalent weight for the specific isocyanate modified epoxy resin (e.g. TDI modified D.E.N.™ 438 epoxy resin or MDI modified D.E.N.™ 438 epoxy resin) was reached. The EEW of the isocyanate modified epoxy resin was measured by the colorimetric titration method stated above. Methyl ester of p-toluene sulfonic acid (MPTS) was added to quench the amine catalyst and to reduce viscosity built-up.

In the case when 2-PhI was used as reaction catalyst, solid 2-PhI 400 ppm (based on the total of epoxy resin and isocyanate in the product) was first dissolved in methanol to give 40 weight % solid solution before addition to the epoxy novolac resin.

### Examples 1 to 9 and Comparative Examples A to C

### Influence of Different Types of Isocyanate Compounds

Isocyanate modified epoxy resins in Comparative Examples A to C and Examples 1-4 were prepared by reacting a multi-functional novolac epoxy resin, D.E.N.™ 438, with different isocyanate compounds including ISONATE™ M229 (Comparative Examples A-C), ISONATE™ M143, ISONATE™ M125, XZ 95263.01, and TDI (Examples 1-9), according to Epoxy Resin Preparation B stated above.

ISONATE™ M229 is the trademark for a MDI sold by The Dow Chemical Company. ISONATE™ M229 has an isocyanate functionality of 2.7.

ISONATE™ M143 is the trademark for a MDI sold by The Dow Chemical Company. ISONATE™ M229 has an isocyanate functionality of 2.15.

ISONATE™ M125 is the trademark for a MDI sold by The Dow Chemical Company. ISONATE™ M125 has an isocyanate functionality of 2.0 and is a crystalline pure MDI mixture comprises approximately 98 percent of 4,4′-MDI and 2 percent of 2,4′-MDI.

XZ 95263.01 is an experimental product sold by The Dow Chemical Company. XZ 95263.01 comprises a mixture of 50 percent of 2,4′- and 50 percent of 4,4′-MDI isomers.

TDI is also a product sold by The Dow Chemical Company which comprises a mixture of 95 percent of 2,4- and 5 percent of 2,6-TDI isomers.

The properties of the isocyanate modified epoxy resin products were measured and the results are listed in Tables 1 and 2.

TABLE 1
Resin Composition and Properties of D.E.N. ™ 438 Epoxy Resin modified
by ISONATE ™ M 229 and ISONATE ™ M143.

| | Comp. | Comp. | Comp. | | | |
|---|---|---|---|---|---|---|
| | Ex. A | Ex. B | Ex. C | Ex. 1 | Ex. 2 | Ex. 3 |
| D.E.N. ™ 438 (wt. %) | 95 | 94 | 93 | 92.5 | 91.5 | 91.5 |
| ISONATE ™ M229 (wt. %) | 5 | 6 | 7 | — | — | — |
| ISONATE ™ M143 (wt. %) | — | — | — | 7.5 | 8.5 | 8.5 |
| Catalyst (ppm) | DBU | DBU | DBU | DBU | DBU | DBU |
| | 1500 | 1500 | 1500 | 1500 | 1500 | 3000 |
| Property: | | | | | | |
| EEW | 198 | 202 | 206 | 219 | 227 | 237 |
| Melt Viscosity (@ 150° C.) | 0.5 | 0.5 | 2 | 0.6 | 0.95 | 2.9 |
| (pascal second) | | | | | | |
| M.S.P (° C.) | 58.6 | 65.8 | 82 | 69 | 76 | 86 |
| Resin Tg (average ° C.) | 11 | 13 | 15 | 24 | 28 | 30 |

TABLE 2
Resin Composition and Properties of D.E.N. ™ 438 Epoxy Resin modified
by ISONATE ™ M125, XZ 95263.01 and TDI.

| | Ex. 4 | Ex. 5 | Ex. 6 | Ex. 7 | Ex. 8 | Ex. 9 |
|---|---|---|---|---|---|---|
| D.E.N. ™ 438 (wt. %) | 89.5 | 89 | 91 | 89 | 89 | 91.3 |
| ISONATE ™ M143 (wt. %) | 10.5 | — | — | — | — | — |
| ISONATE ™ M125 (wt. %) | — | 11 | — | — | — | — |
| XZ 95263.01 (wt. %) | — | — | 9 | 11 | 11 | — |
| TDI (wt. %) | — | — | — | — | — | 8.7 |
| Catalyst (ppm) | DBU | 2-PhI | DBU | DBU | 2-PhI | DBU |
| | 1500 | 400 | 1500 | 2000 | 400 | 2000 |
| Property: | | | | | | |
| EEW | 241 | 257 | 226 | 253 | 254 | 253 |
| Melt Viscosity (@ 150° C.) | 2.4 | 4.8 | 0.9 | 3.2 | 3.9 | 5.1 |
| (pascal second) | | | | | | |
| M.S.P (° C.) | 90 | 96 | 74 | 94 | 95 | NA |
| Resin Tg (average ° C.) | 32 | 36 | 26 | 35 | 35 | 36 |

The results in Tables 1 and 2 show that the multi-functional epoxy resin modified by MDI with functionality in the range of about 2.0 to about 2.15 (ISONATE™ M143, ISONATE™ M125, XZ 95263.01, and TDI) has higher resin softening point compared to epoxy resin modified by MDI with higher functionality of 2.7 (ISONATE™ M229).

The results in Tables 1 and 2 confirm that the higher the isocyanate functionality, the lower the amount of an isocyanate compound which can be reacted with an multi-functional epoxy resin before reaching the gelling point of the multi-functional epoxy resin, thus the lower the softening point of the isocyanate modified epoxy resin end product. The isocyanate compound with higher functionality of 2.7 (ISONATE™ M229) is not suitable to produce an isocyanate modified epoxy resin with high resin softening point (see Comparative Example C) because the isocyanate modified epoxy resin has gelled when the isocyanate content reaches 7%.

Table 2 also shows that it is possible for the epoxy resin modified by the TDI to achieve high melt viscosity and high resin Tg. The TDI comprises two isocyanate groups of different reactivity on a single phenyl ring in its molecule structure and therefore has much higher (approximately 48%) isocyanate content than other isocyanate compounds. These TDI modified epoxy resin can potentially reach very high resin cross-linking Tg when cured with DICY curing agent because of the present of the high level of oxazolidone ring structure in the isocyanate modified epoxy resin.

Both the XZ 95263.01 and TDI modified epoxy resins are solid epoxy resins and can be added to powder coating composition to increase the coating performance with reduced sintering tendency over storage time. The sintering tendency is referred to the tendency for the powder particles to agglomerate to form lumpy block.

### Examples 10 to 16

### Performance of the Epoxy Powder Coating Compositions

The epoxy powder coating compositions in Examples 10-16 are based on D.E.N.™ 438 epoxy resin modified with diisocyanate compounds of XZ 95263.01, TDI, and ISONATE™ M125.

In Table 3, Epoxy Resins A-C were prepared according to Epoxy Resin Preparation B Stated Above:

Epoxy Resin A comprises 89% D.E.N.™ 438 and 11% XZ 95263.01,

Epoxy Resin B comprises 91.3% D.E.N.™ 438 and 8.7% TDI,

Epoxy Resin C comprises 89% D.E.N.™ 438 and 11% ISONATE™ M125.

The properties of the powder coating compositions were measured and summarized in Table 3.

TABLE 3
Powder Coating Performance of D.E.N. ™ 438 Multi-functional Epoxy
Modified by Diisocyanate Compounds

| | Ex. | Ex. | Ex. | Ex. | Ex. | Ex. | Ex. |
|---|---|---|---|---|---|---|---|
| | 10 | 11 | 12 | 13 | 14 | 15 | 16 |
| Epoxy Resin A (grams) | 701.5 | 711.6 | — | — | 718.4 | 718.4 | — |
| Epoxy Resin B(grams) | — | — | 701.5 | 711.6 | — | — | — |
| Epoxy Resin C(grams) | — | — | — | — | — | — | 718.4 |
| DICY (grams) | 14 | — | 14 | — | — | — | — |
| Boric anhydride (grams) | 14 | 14.2 | 14 | 14.2 | — | — | — |
| 2- | 10.5 | 14.2 | 10.5 | 14.2 | 21.6 | 21.6 | 21.6 |
| Phenylimidazole(grams) | | | | | | | |
| TiO₂ (grams) | 50 | 50 | 50 | 50 | 50 | 50 | 50 |
| BaSO₄ (grams) | 200 | 200 | 200 | 200 | 200 | 200 | 200 |
| Modaflow (grams) | 10 | 10 | 10 | 10 | 10 | 10 | 10 |
| Total (grams) | 1000 | 1000 | 1000 | 1000 | 1000 | 1000 | 1000 |
| Extrusion (° C.) | 90 | 90 | 98 | 98 | 90 | 85 | 85 |
| Resin Cross-linked Tg's | 194 | 190 | 194 | 193 | 203 | 200 | 203 |
| (° C.) | | | | | | | |
| Reactivity (Gel time | 36 | 26 | 26 | 33 | 20 | 15 | 17 |
| 180°) (seconds) | | | | | | | |
| Chemical Resistance | >200 | 10 | 200 | 20 | >200 | >200 | >200 |
| (Aceton Dle rubs) | | | | | | | |
| Impact Resistance | 140 | 50 | 64 | 32 | 32 | 50 | 50 |
| (lbs/in) | | | | | | | |
| Hot Water Resistance | 2 | 2.5 | 3 | 2 | 1.5 | 1.5 | 2 |
| (scale of 1-5 with 1: best | | | | | | | |
| and 5: worse) | | | | | | | |
| Flexibility, Bend Angle | <10 | 10 | 10 | <10 | <10 | <10 | <10 |
| (degrees) | | | | | | | |

As shown in Table 3, the resin cross-linked Tg of Examples 10-16 ranges from 190° C. to greater than about 200° C. when standard curing agent such as DICY hardener and curing catalyst such as 2-phenylimidazole were used in formulating the D.E.N.™ 438 based powder coating compositions. The resin cross-linked Tg in Examples 14 to 16 exhibited the highest resin cross-linked Tg with the Tg being greater than about 200° C.

Resin Cross-linked Tg of the Epoxy Powder Coating Compositions

Table 4 summarizes the resin cross-linked Tg of different epoxy powder coating compositions based on di-functional epoxy resin, D.E.R.™ 330, and multi-functional novolac epoxy resin, D.E.N.™ 438. Both epoxy resins are modified by diisocyanate compounds of XZ 95263.0, ISONATE™ M125, and TDI, according to Epoxy Resin Preparation A and B, respectively.

TABLE 4
Resin Cross-linked Tg of Epoxy Powder Coating Compositions.

| | |
|---|---|
| | Resin Cross-linked Tg |
| Powder Coating Composition | (° C.) |

| | | |
|---|---|---|
| D.E.N. ™ 438 | XZ 95263.01 | 190-203 |
| D.E.N. ™ 438 | ISONATE ™ M125 | 203 |
| D.E.N. ™ 438 | TDI | 193-194 |
| D.E.R. ™ 330 | XZ 95263.01 | 144-151 |
| D.E.R. ™ 330 | ISONATE ™ M125 | 144-149 |
| D.E.R. ™ 330 | TDI | 156-183 |

The results in Table 4 show the epoxy powder compositions comprising multi-functional epoxy resin D.E.N.™ 438 having a much higher resin cross-linked Tg than that of the epoxy powder compositions comprising di-functional epoxy resin D.E.R.™ 330.

It will be obvious to persons skilled in the art that certain changes may be made in the methods described above without departing from the scope of the invention. It is therefore intended that all matter herein disclosed be interpreted as illustrative only and not as limiting the scope of protection sought. Moreover, the process of the present invention is not to be limited by the specific examples set forth above including the tables to which they refer. Rather, these examples and the tables they refer to are illustrative of the process of the invention.

What is claimed is:

1. An epoxy resin composition comprising an isocyanate modified epoxy resin, wherein the isocyanate modified epoxy resin is a reaction product of (a) a multi-functional epoxy resin having an epoxy functionality of greater than about 2.2 and (b) a diisocyanate compound.

2. The composition according to claim 1, wherein the multi-functional epoxy resin has an epoxy functionality of greater than about 2.5.

3. The composition according to claim 2, wherein the multi-functional epoxy resin has an epoxy functionality of greater than about 3.0.

4. The composition according to claim 3, wherein the multi-functional epoxy resin has an epoxy functionality of greater than about 3.5.

5. The composition according to claim 1, wherein the multi-functional epoxy resin has an epoxy functionality of about 2.5 to about 10.

6. The composition according to claim 5, wherein the multi-functional epoxy resin has an epoxy functionality of about 3.0 to about 8.

7. The composition according to claim 6, wherein the multi-functional epoxy resin has an epoxy functionality of about 3.5 to about 6.

8. The composition according to claim 1, wherein the multi-functional epoxy resin is at least one of a multi-functional epoxy novolac resin, an epoxidized bisphenol A novolac resin, a dicyclopentadiene modified epoxy, a trisepoxy, a cresol epoxy novolac, alkylated epoxy novolacs, tetra functional epoxy, and any combination thereof.

9. The composition according to claim 8, wherein the multi-functional epoxy resin is a multi-functional epoxy novolac resin.

10. The composition according to claim 1, wherein the diisocyanate compound has an isocyanate functionality of from about 2.0 to about 2.4.

11. The composition according to claim 10, wherein the diisocyanate compound has an isocyanate functionality of from about 2.05 to about 2.3.

12. The composition according to claim 11, wherein the diisocyanate compound has an isocyanate functionality of from about 2.1 to about 2.25.

13. The composition according to claim 1, wherein the diisocyanate compound comprises at least one of a toluene diisocyanate (TDI) and its isomers, a methylene bis(phenyl isocyanate) (MDI) and its isomers, and any mixture thereof.

14. The composition according to claim 13, wherein the diisocyanate compound comprises at least one of the TDI, its isomers, and any mixture thereof.

15. The composition according to claim 14, wherein the diisocyanate compound comprises at least one of 2,2′-, 2,4′- and 4,4′-isomers of the TDI and any mixture thereof.

16. The composition according to claim 13, wherein the diisocyanate compound comprises at least one of the MDI, its isomers, and any mixture thereof.

17. The composition according to claim 16, wherein the diisocyanate compound comprises at least one of 2,4- and 2,6-isomers of the MDI and any mixture thereof.

18. The composition according to claim 1, wherein the multi-functional epoxy resin is from about 98 percent to about 75 percent by weight based on the total weight of the multi-functional epoxy resin and the isocyanate compound in the composition.

19. The composition according to claim 18, wherein the multi-functional epoxy resin is from about 95 percent to about 85 percent by weight based on the total weight of the multi-functional epoxy resin and the isocyanate compound in the composition.

20. The composition according to claim 1, wherein the isocyanate modified epoxy resin comprises a hybrid of oxazolidone/isocyanurate rings.

21. The composition according to claim 1 further comprising a catalyst.

22. The composition according to claim 21, wherein the catalyst comprises at least one of a compound containing amine, phosphine, ammonium, phosphonium, arsonium, or sulfonium moiety.

23. The composition according to claim 22, wherein the catalyst comprises at least one of 2-methyl imidazole, 2-phenyl imidazole, 1,8-Diazabicyclo[5.4.0]undec-7-ene (DBU), and any combination thereof.

24. An epoxy powder coating composition comprising the epoxy resin composition according to claim 1.

25. The composition according to claim 24 further comprising a catalyst, a curing agent, and an additive.

26. The composition according to claim 25, wherein the catalyst comprises at least one of a compound containing amine, phosphine, ammonium, phosphonium, arsonium, or sulfonium moiety.

27. The composition according to claim 26, wherein the catalyst comprises at least one of 2-methyl imidazole, 2-phenyl imidazole, imidazole derivative, 1,8-Diazabicyclo[5.4.0]undec-7-ene (DBU), 2-methylimidazole-epoxy adduct, isocyanate-amine adduct, and any combination thereof.

28. The composition according to claim 25, wherein the catalyst further comprises a Lewis acid.

29. The composition according to claim 28, wherein the Lewis acid comprises at least one of halides, oxides, hydroxides and alkoxides of zinc, tin, titanium, cobalt, manganese, iron, silicon, aluminum, boron, and any combination thereof.

30. The composition according to claim 29, wherein the Lewis acid comprises at least one of boric acid, metaboric acid, substituted and unsubstituted boroxine, substituted and unsubstituted borate, boron oxide, boron halide, and any combination thereof.

31. The composition according to claim 28, wherein the catalyst comprises a mixture of the Lewis acid and an amine catalyst.

32. The composition according to claim 31, wherein the amount of the Lewis acid is at least about 0.1 moles of Lewis acid per mole of amine catalyst.

33. The composition according to claim 32, wherein the amount of the Lewis acid is at least about 0.3 moles of Lewis acid per mole of amine catalyst.

34. The composition according to claim 31, wherein the amount of the Lewis acid is no more than about 5 moles of Lewis acid per mole of amine catalyst.

35. The composition according to claim 34, wherein the amount of the Lewis acid is no more than about 3 moles of Lewis acid per mole of amine catalyst.

36. The composition according to claim 31, wherein the amount of the Lewis acid is at least about 0.1 moles and no more than about 5 moles of Lewis acid per mole of amine catalyst.

37. The composition according to claim 36, wherein the amount of the Lewis acid is at least about 0.3 moles and no more than about 3 moles of Lewis acid per mole of amine catalyst.

38. The composition according to claim 25, wherein the curing agent comprises dicyandiamide, phenol novolacs, bisphenol-A novolacs, phenol novolac of dicyclopentadiene, diphenylsulfone, styrene-maleic acid anhydride copolymers (SMA), and any combination thereof.

39. The composition according to claim 25, wherein the additive comprises BaSO₄ and TiO₂.

40. The composition according to claim 24, wherein the composition has a resin cross-linked glass transition temperature Tg greater than about 160° C.

41. The composition according to claim 40, wherein the resin cross-linked glass transition temperature is greater than about 190° C.

42. The composition according to claim 41, wherein the resin cross-linked glass transition temperature is greater than about 200° C.

43. The composition according to claim 42, wherein the resin cross-linked glass transition temperature is about 200° C. to about 250° C.

44. An article comprising the epoxy powder coating composition of claim 24.

45. The article according to claim 44, wherein the article is an electrical laminate or electrical encapsulation.

46. The article according to claim 45, wherein the article is a gas or oil pipe.
